(19) United States
(12) Patent Application Publication
(10) Pub. No.: US 2016/0305374 A1
(43) Pub. Date: Oct. 20, 2016

(54) METHOD AND SYSTEMS FOR MANAGING CONDENSATE

(71) Applicant: General Electric Company, Schenectady, NY (US)

(72) Inventors: Vijayaselvan Jayakar, Bangalore (IN); Pranav Raina, Bangalore (IN); Laus Lynd Deo, Bangalore (IN)

(21) Appl. No.: 15/096,391

(22) Filed: Apr. 12, 2016

Related U.S. Application Data
(60) Provisional application No. 62/147,072, filed on Apr. 14, 2015.

(51) Int. Cl. F02M 26/35; F02M 26/14; F02B 29/04; F02M 26/19; F02M 26/05; F02M 26/30

(52) U.S. Cl. CPC F02M 26/35; F02M 26/05; F02M 26/30; F02B 29/0406; F02M 26/19; F02M 26/14

(57) ABSTRACT

Various methods and systems are provided for managing condensation. In one example, a system comprises an engine; an intercooler positioned in an intake passage downstream of a first turbocharger compressor; an exhaust gas recirculation (EGR) system including an EGR cooler defining at least a portion of an EGR passage and communicating with a mixing region where exhaust gas mixes with the compressed intake air; a condensate collector fluidly coupled to the EGR cooler to collect condensate from the EGR cooler, the condensate collector positioned within the EGR cooler; and a drain line coupled to the condensate collector, the drain line having an outlet fluidically coupled to a turbocharger turbine outlet.

### CROSS REFERENCE TO RELATED APPLICATIONS

This application claims priority to U.S. Provisional Application No. 62/147,072, entitled “METHOD AND SYSTEMS FOR MANAGING CONDENSATE,” filed Apr. 14, 2015, the entire contents of which is hereby incorporated by reference for all purposes.

### BACKGROUND

### Technical Field

Embodiments of the subject matter disclosed herein relate to engine systems.

### DISCUSSION OF ART

In order to meet emissions standards mandated by various emissions regulating agencies, internal combustion engines may be configured with various after treatment devices, such as selective catalytic reduction systems, and/or with exhaust gas recirculation (EGR) to lower emission production and remove emissions from the exhaust. Further, while the environmental risks of sulfur in fuel are widely recognized, mandates limiting the amount of sulfur in fuel have not been implemented across the globe. When the fuel containing sulfur burns inside the engine combustion chamber, it forms sulfur oxides. In engine systems that include EGR, the exhaust gas containing sulfur oxides, when cooled in an EGR cooler, for example, forms acidic condensate. The quantity of acidic condensate formed depends on the sulfur content in the fuel and the engine operating conditions. Unless removed from the system, the condensed acidic medium starts corroding the EGR cooler and the other engine parts resulting in premature engine failure.

### BRIEF DESCRIPTION

In one embodiment, a system includes an engine, an intercooler positioned in an intake passage downstream of a turbocharger compressor, an exhaust gas recirculation (EGR) system including an EGR cooler defining at least a portion of an EGR passage and communicating with a mixing region where exhaust gas mixes with the compressed intake air, a condensate collector fluidly coupled to the EGR cooler to collect condensate from the EGR cooler, and a drain line coupled to the condensate collector. The condensate collector is positioned within the EGR cooler, and the drain line has an outlet fluidically coupled downstream of a turbocharger turbine.

### BRIEF DESCRIPTION OF THE DRAWINGS

FIG. 1 shows a vehicle system including a first example of a condensation management system.

FIG. 2 shows the vehicle system of FIG. 1 including a second example of a condensation management system.

FIG. 3 shows the vehicle system of FIG. 1 including a third example of a condensation management system.

FIG. 4 shows the vehicle system of FIG. 1 including a fourth example of a condensation management system.

FIG. 5 shows the vehicle system of FIG. 1 including a fifth example of a condensation management system.

FIGS. 6A, 6B, 7A, and 7B illustrate an example of an EGR cooler.

FIG. 8 is an example of a condensation management system.

FIG. 9 is another example of a condensation management system.

FIG. 10 shows an embodiment of a condensation management system with an EGR condensate line.

FIG. 11 illustrates an example of an EGR cooler.

FIG. 12 shows another view of the EGR cooler of FIG. 11.

### DETAILED DESCRIPTION

The following description relates to embodiments of a system for managing condensate that may accumulate in an engine intake and/or exhaust gas recirculation (EGR) system. In particular, the EGR system may include an EGR cooler that accumulates acidic condensation due to the presence of sulfur in fuel combusted in the engine, and the condensation management system includes mechanisms for preventing the acidic condensation from corroding the EGR cooler and/or engine. Such mechanisms may include a storage tank for collecting the condensate, located on the EGR cooler or remote from the EGR cooler, a heater to increase the temperature of the EGR cooler to prevent formation of condensation, and/or providing corrosion-resistant materials within the EGR cooler.

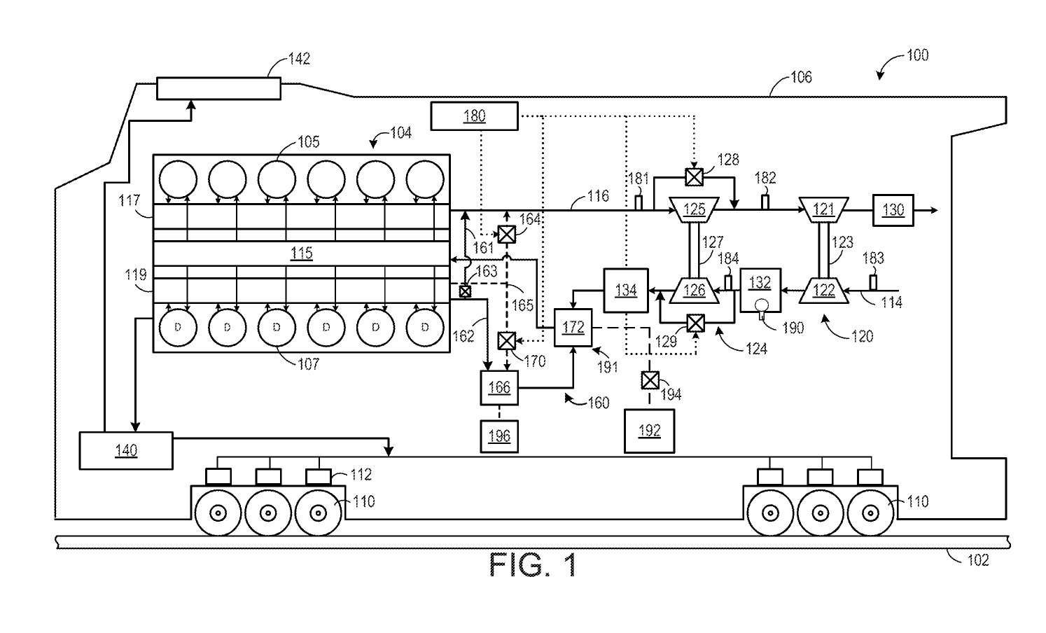

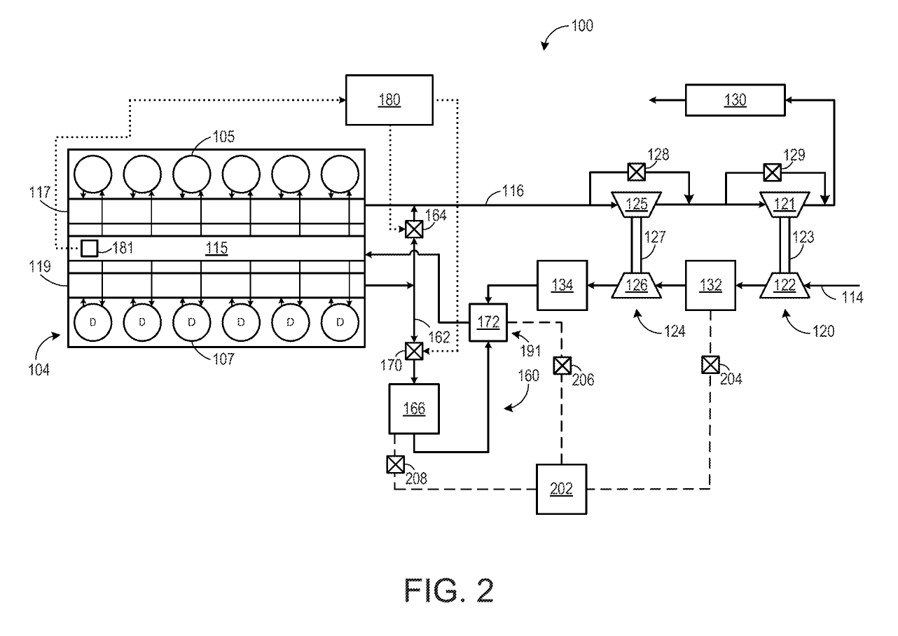

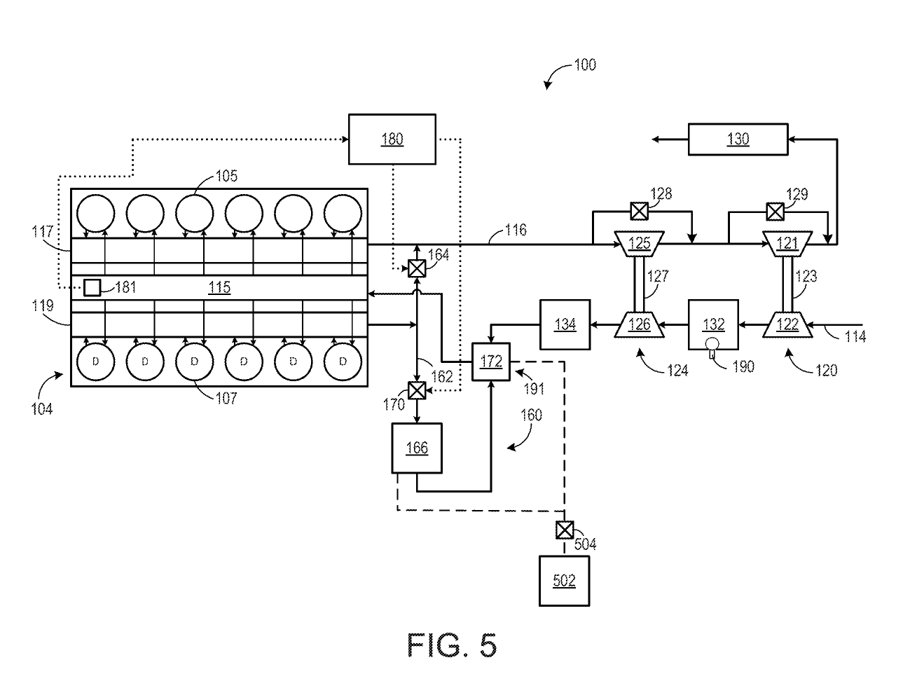

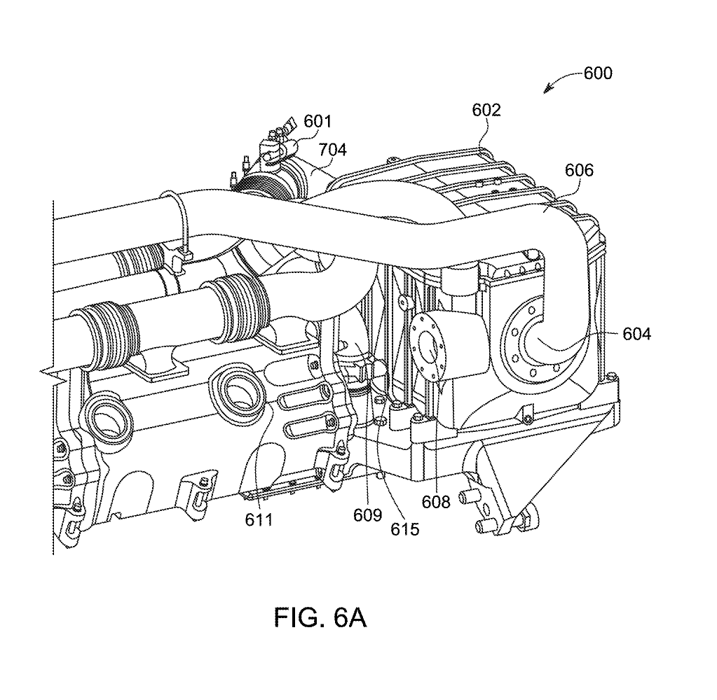

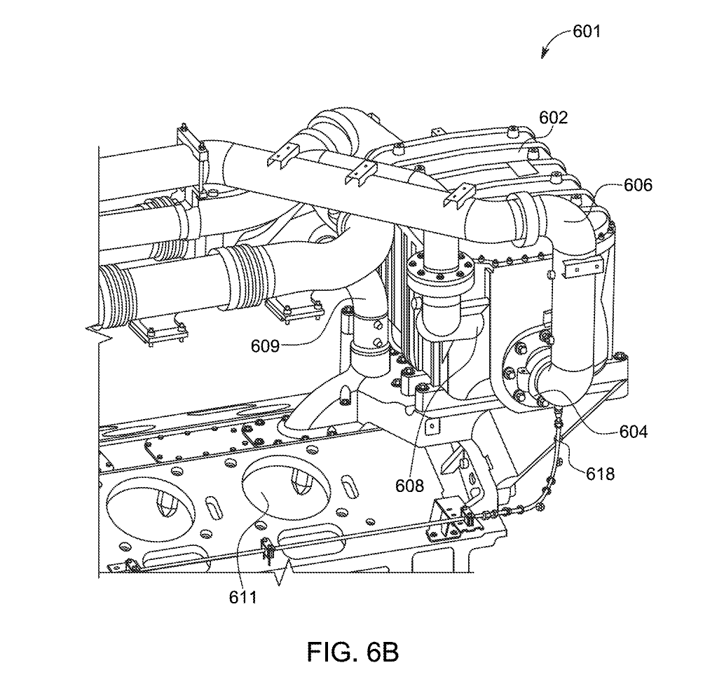

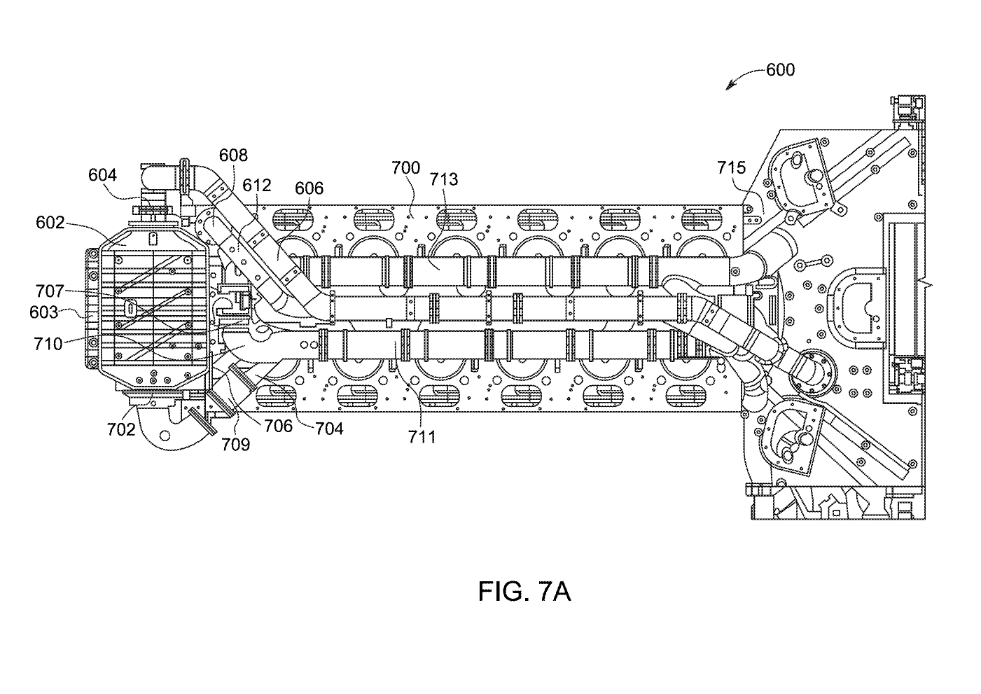

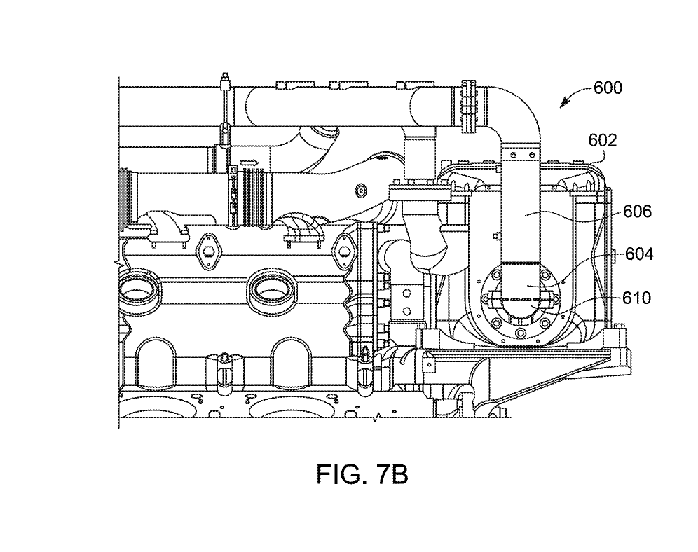

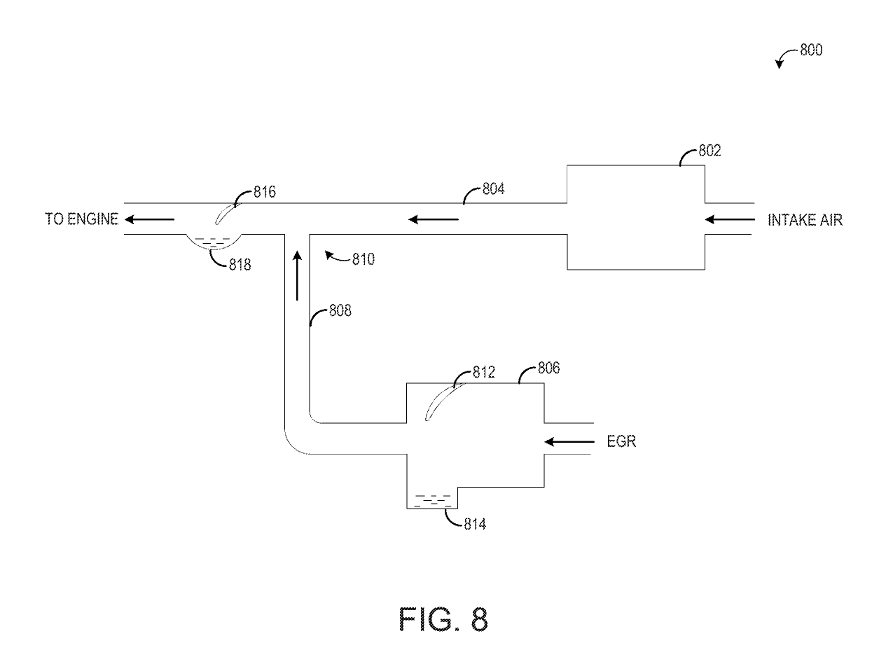

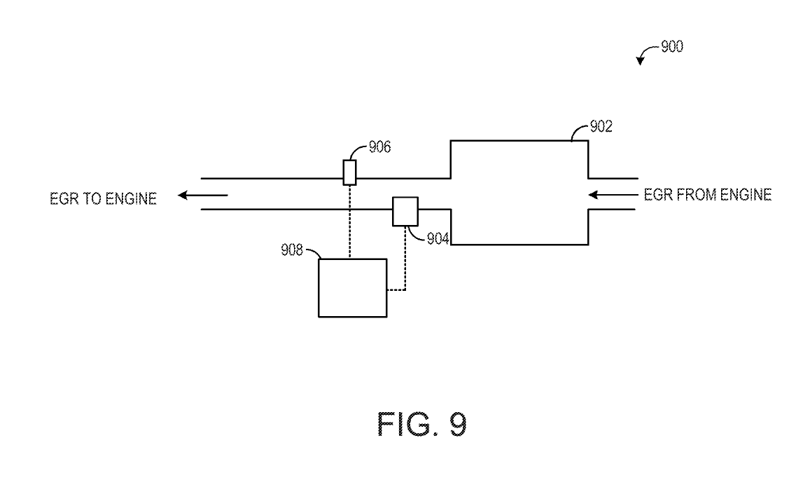

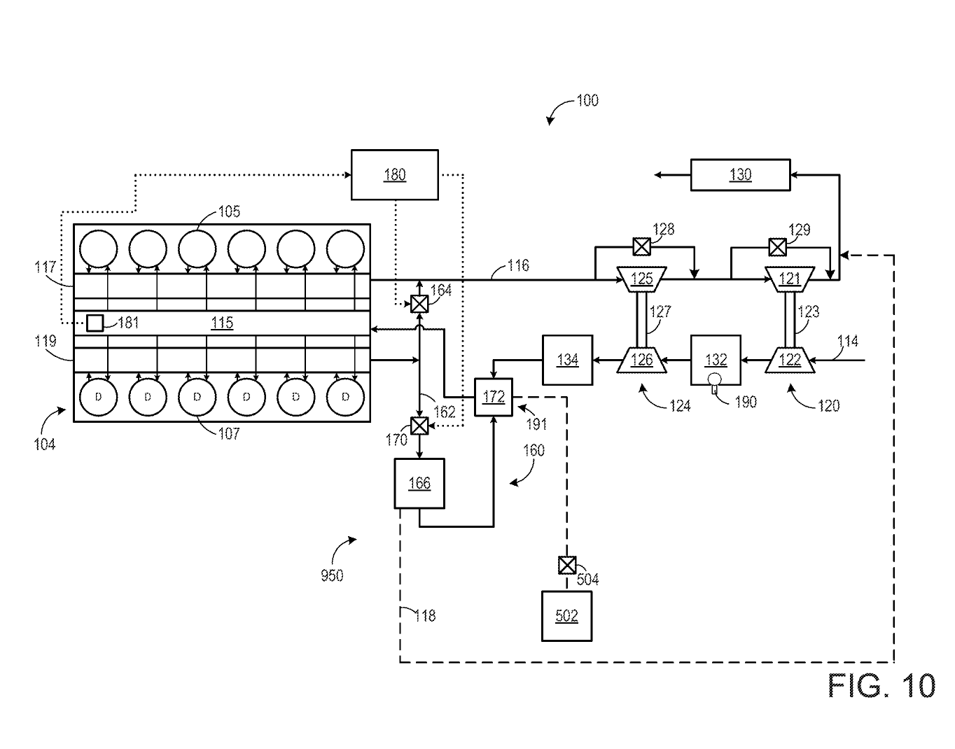

Engine systems, such as the engine system shown in FIG. 1, may include a condensation management system. The condensation management system may include draining condensate from one or more intercoolers, from mixing area/s and from an EGR cooler to a common storage tank, which may be located away from the engine at a vessel. The flow of condensate to the common storage tank may be enabled by using a combination of one or more valves and condensate flow paths to drain the condensate along a pressure gradient, as illustrated in embodiments in FIGS. 2-4. FIG. 5 illustrates a single automatic valve regulating the draining of condensate. An EGR cooler with inlets and outlets for flow of fluids through the EGR cooler is illustrated in FIGS. 6A, 6B, 7A, and 7B. FIGS. 8-9 show schematics of condensate management in an engine system coupled to an EGR cooler. A condensate evacuation line to drain condensate from the EGR cooler to the exhaust passage is shown in the embodiments of the condensate management system illustrated in FIGS. 10-12.

FIGS. 1-12 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 6A, 6B, 7A, 7B, 11, and 12 are drawn approximately to scale, although other relative dimensions may be used, if desired.

The approach described herein may be employed in a variety of engine types, and a variety of engine-driven systems. Some of these systems may be stationary, while others may be on semi-mobile or mobile platforms. Semi-mobile platforms may be relocated between operational periods, such as mounted on flatbed trailers. Mobile platforms include self-propelled vehicles. Such vehicles can include on-road transportation vehicles, as well as mining equipment, marine vessels, rail vehicles, and other off-highway vehicles (OHV). For clarity of illustration, a locomotive is provided as an example of a mobile platform supporting a system incorporating an embodiment of the invention.

Before further discussion of the approach for managing condensation in an engine system, an example of a platform is disclosed in which an engine may be configured for a vehicle, such as a rail vehicle. For example, FIG. 1 shows a block diagram of an embodiment of a vehicle system 100 (e.g., a locomotive system), herein depicted as a rail vehicle 106, configured to run on a rail 102 via a plurality of wheels 110. As depicted, the rail vehicle 106 includes an engine 104. In other non-limiting embodiments, the engine 104 may be a stationary engine, such as in a power-plant application, or an engine in a marine vessel or off-highway vehicle propulsion system as noted above.

The engine 104 receives intake air for combustion from an intake, such as an intake manifold 115. The intake may be any suitable conduit or conduits through which gases flow to enter the engine. For example, the intake may include the intake manifold 115, the intake passage 114, and the like. The intake passage 114 receives ambient air from an air filter (not shown) that filters air from outside of a vehicle in which the engine 104 may be positioned. Exhaust gas resulting from combustion in the engine 104 is supplied to an exhaust, such as exhaust passage 116. The exhaust may be any suitable conduit through which gases flow from the engine. For example, the exhaust may include an exhaust manifold 117, the exhaust passage 116, and the like. Exhaust gas flows through the exhaust passage 116, and out of an exhaust stack of the rail vehicle 106. In one example, the engine 104 is a diesel engine that combusts air and diesel fuel through compression ignition. In other non-limiting embodiments, the engine 104 may combust fuel including gasoline, kerosene, biodiesel, or other petroleum distillates of similar density through compression ignition (and/or spark ignition).

In one embodiment, the rail vehicle 106 is a diesel-electric vehicle. As depicted in FIG. 1, the engine 104 is coupled to an electric power generation system, which includes an alternator/generator 140 and electric traction motors 112. For example, the engine 104 is a diesel engine that generates a torque output that is transmitted to the alternator/generator 140 which is mechanically coupled to the engine 104. The alternator/generator 140 produces electrical power that may be stored and applied for subsequent propagation to a variety of downstream electrical components. As an example, the alternator/generator 140 may be electrically coupled to a plurality of traction motors 112 and the alternator/generator 140 may provide electrical power to the plurality of traction motors 112. As depicted, the plurality of traction motors 112 are each connected to one of a plurality of wheels 110 to provide tractive power to propel the rail vehicle 106. One example configuration includes one traction motor per wheel. As depicted herein, six pairs of traction motors correspond to each of six pairs of wheels of the rail vehicle. In another example, alternator/generator 140 may be coupled to one or more resistive grids 142. The resistive grids 142 may be configured to dissipate excess engine torque via heat produced by the grids from electricity generated by alternator/generator 140.

In the embodiment depicted in FIG. 1, the engine 104 is a V-12 engine having twelve cylinders. In other examples, the engine may be a V-6, V-8, V-10, V-16, I-4, I-6, 1-8, opposed 4, or another engine type. As depicted, the engine 104 includes a subset of non-donor cylinders 105, which includes six cylinders that supply exhaust gas exclusively to a non-donor cylinder exhaust manifold 117, and a subset of donor cylinders 107, which includes six cylinders that supply exhaust gas exclusively to a donor cylinder exhaust manifold 119. In other embodiments, the engine may include at least one donor cylinder and at least one non-donor cylinder. For example, the engine may have four donor cylinders and eight non-donor cylinders, or three donor cylinders and nine non-donor cylinders. In some examples, the engine may have an equal number of donor and non-donor cylinders. In other examples, the engine may have more donor cylinders than non-donor cylinders. In still further examples, the engine may be comprised entirely of donor cylinders. It should be understood, the engine may have any desired numbers of donor cylinders and non-donor cylinders.

As depicted in FIG. 1, the non-donor cylinders 105 are coupled to the exhaust passage 116 to route exhaust gas from the engine to atmosphere (after it passes through an exhaust gas treatment system 130 and first and second turbochargers 120 and 124). The donor cylinders 107, which provide engine exhaust gas recirculation (EGR), are coupled exclusively to an EGR passage 162 of an EGR system 160 which routes exhaust gas from the donor cylinders 107 to the intake passage 114 of the engine 104, and not to atmosphere. By introducing cooled exhaust gas to the engine 104, the amount of available oxygen for combustion is decreased, thereby reducing combustion flame temperatures and reducing the formation of nitrogen oxides (e.g., NOR).

Exhaust gas flowing from the donor cylinders 107 to the intake passage 114 passes through a heat exchanger such as an EGR cooler 166 to reduce a temperature of (e.g., cool) the exhaust gas before the exhaust gas returns to the intake passage. The EGR cooler 166 may be an air-to-liquid heat exchanger, for example. In such an example, one or more charge air coolers 132 and 134 disposed in the intake passage 114 (e.g., upstream of where the recirculated exhaust gas enters) may be adjusted to further increase cooling of the charge air such that a mixture temperature of charge air and exhaust gas is maintained at a desired temperature. In other examples, the EGR system 160 may include an EGR cooler bypass. Alternatively, the EGR system may include an EGR cooler control element. The EGR cooler control element may be actuated such that the flow of exhaust gas through the EGR cooler is reduced; however, in such a configuration, exhaust gas that does not flow through the EGR cooler is directed to the exhaust passage 116 rather than the intake passage 114.

Additionally, in some embodiments, the EGR system 160 may include an EGR bypass passage 161 that is configured to divert exhaust from the donor cylinders back to the exhaust passage. The EGR bypass passage 161 may be controlled via a valve 163. The valve 163 may be configured with a plurality of restriction points such that a variable amount of exhaust is routed to the exhaust, in order to provide a variable amount of EGR to the intake.

In an alternate embodiment shown in FIG. 1, the donor cylinders 107 may be coupled to an alternate EGR passage 165 (illustrated by the dashed lines) that is configured to selectively route exhaust to the intake or to the exhaust passage. For example, when a second valve 170 is open, exhaust may be routed from the donor cylinders to the EGR cooler 166 and/or additional elements prior to being routed to the intake passage 114. Further, the alternate EGR system includes a first valve 164 disposed between the exhaust passage 116 and the alternate EGR passage 165.

The first valve 164 and second valve 170 may be on/off valves controlled by the control unit 180 (for turning the flow of EGR on or off), or they may control a variable amount of EGR, for example. In some examples, the first valve 164 may be actuated such that an EGR amount is reduced (exhaust gas flows from the EGR passage 165 to the exhaust passage 116). In other examples, the first valve 164 may be actuated such that the EGR amount is increased (e.g., exhaust gas flows from the exhaust passage 116 to the EGR passage 165). In some embodiments, the alternate EGR system may include a plurality of EGR valves or other flow control elements to control the amount of EGR.

In such a configuration, the first valve 164 is operable to route exhaust from the donor cylinders to the exhaust passage 116 of the engine 104 and the second valve 170 is operable to route exhaust from the donor cylinders to the intake passage 114 of the engine 104. As such, the first valve 164 may be referred to as an EGR bypass valve, while the second valve 170 may be referred to as an EGR metering valve. In the embodiment shown in FIG. 1, the first valve 164 and the second valve 170 may be engine oil, or hydraulically, actuated valves, for example, with a shuttle valve (not shown) to modulate the engine oil. In some examples, the valves may be actuated such that one of the first and second valves 164 and 170 is normally open and the other is normally closed. In other examples, the first and second valves 164 and 170 may be pneumatic valves, electric valves, or another suitable valve.

As shown in FIG. 1, the vehicle system 100 further includes an EGR mixer 172 which mixes the recirculated exhaust gas with charge air such that the exhaust gas may be evenly distributed within the charge air and exhaust gas mixture. In the embodiment depicted in FIG. 1, the EGR system 160 is a high-pressure EGR system which routes exhaust gas from a location upstream of turbochargers 120 and 124 in the exhaust passage 116 to a location downstream of turbochargers 120 and 124 in the intake passage 114. In other embodiments, the vehicle system 100 may additionally or alternatively include a low-pressure EGR system which routes exhaust gas from downstream of the turbochargers 120 and 124 in the exhaust passage 116 to a location upstream of the turbochargers 120 and 124 in the intake passage 114.

As depicted in FIG. 1, the vehicle system 100 further includes a two-stage turbocharger with the first turbocharger 120 and the second turbocharger 124 arranged in series, each of the turbochargers 120 and 124 arranged between the intake passage 114 and the exhaust passage 116. The two-stage turbocharger increases air charge of ambient air drawn into the intake passage 114 in order to provide greater charge density during combustion to increase power output and/or engine-operating efficiency. The first turbocharger 120 operates at a relatively lower pressure, and includes a first turbine 121 which drives a first compressor 122. The first turbine 121 and the first compressor 122 are mechanically coupled via a first shaft 123. The first turbocharger may be referred to the “low-pressure stage” of the turbocharger. The second turbocharger 124 operates at a relatively higher pressure, and includes a second turbine 125 which drives a second compressor 126. The second turbocharger may be referred to the “high-pressure stage” of the turbocharger. The second turbine and the second compressor are mechanically coupled via a second shaft 127.

As explained above, the terms “high pressure” and “low pressure” are relative, meaning that “high” pressure is a pressure higher than a “low” pressure. Conversely, a “low” pressure is a pressure lower than a “high” pressure.

As used herein, “two-stage turbocharger” may generally refer to a multi-stage turbocharger configuration that includes two or more turbochargers. For example, a two-stage turbocharger may include a high-pressure turbocharger and a low-pressure turbocharger arranged in series, three turbocharger arranged in series, two low pressure turbochargers feeding a high pressure turbocharger, one low pressure turbocharger feeding two high pressure turbochargers, etc. In one example, three turbochargers are used in series. In another example, only two turbochargers are used in series.

In the embodiment shown in FIG. 1, the second turbocharger 124 is provided with a turbine bypass valve 128 which allows exhaust gas to bypass the second turbocharger 124. The turbine bypass valve 128 may be opened, for example, to divert the exhaust gas flow away from the second turbine 125. In this manner, the rotating speed of the compressor 126, and thus the boost provided by the turbochargers 120, 124 to the engine 104 may be regulated during steady state conditions. Additionally, the first turbocharger 120 may also be provided with a turbine bypass valve. In other embodiments, only the first turbocharger 120 may be provided with a turbine bypass valve, or only the second turbocharger 124 may be provided with a turbine bypass valve. Additionally, the second turbocharger may be provided with a compressor bypass valve 129, which allows gas to bypass the second compressor 126 to avoid compressor surge, for example. In some embodiments, first turbocharger 120 may also be provided with a compressor bypass valve, while in other embodiments, only first turbocharger 120 may be provided with a compressor bypass valve.

While not shown in FIG. 1, in some examples two low-pressure turbochargers may be present. As such, two charge air coolers (e.g., intercoolers) may be present, one positioned downstream of each low-pressure compressor. In one example, the low-pressure turbochargers may be present in parallel, such that charge air that flows through each low-pressure compressor is combined and directed to the high-pressure compressor.

While in the example vehicle system described herein with respect to FIG. 1 includes a two-stage turbocharger, it is to be understood that other turbocharger arrangements are possible. In one example, only a single turbocharger may be present. In such cases, only one charge air cooler may be utilized, rather than the two coolers depicted in FIG. 1 (e.g., intercooler 132 and aftercooler 134). In some examples, a turbo-compounding system may be used, where a turbine positioned in the exhaust passage is mechanically coupled to the engine. Herein, energy extracted from the exhaust gas by the turbine is used to rotate the crankshaft to provide further energy for propelling the vehicle system. Still other turbocharger arrangements are possible.

The vehicle system 100 optionally includes an exhaust treatment system 130 coupled in the exhaust passage in order to reduce regulated emissions. As depicted in FIG. 1, the exhaust gas treatment system 130 is disposed downstream of the turbine 121 of the first (low pressure) turbocharger 120. In other embodiments, an exhaust gas treatment system may be additionally or alternatively disposed upstream of the first turbocharger 120. The exhaust gas treatment system 130 may include one or more components. For example, the exhaust gas treatment system 130 may include one or more of a diesel particulate filter (DPF), a diesel oxidation catalyst (DOC), a selective catalytic reduction (SCR) catalyst, a three-way catalyst, a NOx trap, and/or various other emission control devices or combinations thereof. However, in some examples the exhaust aftertreatment system 130 may be dispensed with and the exhaust may flow from the exhaust passage to atmosphere without flowing through an aftertreatment device.

The vehicle system 100 further includes the control unit 180, which is provided and configured to control various components related to the vehicle system 100. In one example, the control unit 180 includes a computer control system. The control unit 180 further includes non-transitory, computer readable storage media (not shown) including code for enabling on-board monitoring and control of engine operation. The control unit 180, while overseeing control and management of the vehicle system 100, may be configured to receive signals from a variety of engine sensors, as further elaborated herein, in order to determine operating parameters and operating conditions, and correspondingly adjust various engine actuators to control operation of the vehicle system 100. For example, the control unit 180 may receive signals from various engine sensors including sensor 181 arranged in the inlet of the high-pressure turbine, sensor 182 arranged in the inlet of the low-pressure turbine, sensor 183 arranged in the inlet of the low-pressure compressor, and sensor 184 arranged in the inlet of the high-pressure compressor. The sensors arranged in the inlets of the turbochargers may detect air temperature and/or pressure. Additional sensors may include, but are not limited to, engine speed, engine load, boost pressure, ambient pressure, exhaust temperature, exhaust pressure, etc. Correspondingly, the control unit 180 may control the vehicle system 100 by sending commands to various components such as traction motors, alternator, cylinder valves, throttle, heat exchangers, wastegates or other valves or flow control elements, etc.

During operation, the vehicle system 100 intakes air via the intake passage and combusts the air with fuel to produce exhaust that is directed out of the vehicle via the exhaust passage. Under certain conditions, the intake air and/or the exhaust may deposit condensation on various vehicle system surfaces. Condensation occurs when the temperature of the surfaces in contact with intake air and/or exhaust drops below the dew point of the air in contact with the surfaces. Certain locations in the vehicle system are prone to accumulating condensation, due to exposure to relatively humid air and low temperatures, in particular the charge air coolers 132 and 134 (also referred to as an intercooler 132 and aftercooler 134), EGR mixer 172, and the EGR cooler 166. Accumulated condensate can cause system degradation. For example, condensate that accumulates in the intercooler and/or aftercooler may be swept to the engine during an acceleration event, causing misfire and engine degradation. Condensate that accumulates in the EGR cooler may cause corrosion due to the acidic nature of the condensation, as explained above.

Thus, as will be described in more detail below, the vehicle system may include various mechanisms for managing condensation to avoid EGR cooler corrosion and other degradation. FIGS. 1-5 each illustrate one example configuration for managing condensate in the vehicle system. The vehicle system illustrated in FIGS. 2-5 is the same vehicle system described above, other than differences in the condensation management system described below.

Referring first to the condensate management configuration of FIG. 1, condensate that accumulates in the intercooler 132 may be periodically drained from the intercooler 132 via an automatic valve 190. The automatic valve may be a mechanical valve or it may be an electric valve. As illustrated, automatic valve 190 is a spherical bob that is configured to seal a drain hole out of the intercooler when the accumulated condensate is less than a threshold level. Then, once condensate accumulates above the threshold level, the spherical bob floats and opens the drain hole, allowing the condensate to drain out of the intercooler. In this way, the drain hole is always sealed from the intake air flowing through the intercooler, to prevent any air from leaking out of the system. When the valve is closed, the valve seals the drain hole and prevents intake air from leaking. When the valve is open, the condensate (e.g., water) acts as a seal over the drain hole, to prevent intake air from leaking.

While not shown in FIG. 1, in some examples, an automatic valve may be present in the aftercooler 134 as well as the intercooler 132. Further, in some examples, the automatic valve may open based on a command from the controller, in response to an indication that condensate in the intercooler has reached the threshold level.

Condensate may also accumulate at a mixing region 191 where EGR is mixed with intake air upstream of the engine. As shown in FIG. 1, the mixing region is at EGR mixer 172; however, in other examples the EGR may be introduced just upstream of the EGR mixer, or it may introduced at the aftercooler 134. The accumulated condensate at the mixing region may include some acidic condensation due to the sulfuric acid in the exhaust recirculated from the engine. Thus, unlike condensate that accumulates in the intercooler, the condensate at the mixing region may include at least some sulfuric acid and thus may be collected in a storage tank 192. A valve 194 may control flow of condensate to storage tank 192. The valve 194 may be an automatic valve that is mechanically, pneumatically, or electrically opened in response to a command from the controller, for example.

Further, a storage tank 196 may collect condensate from EGR cooler 166. The storage tank 196 may be relatively small (e.g., two liters) due to the relatively small amount of condensate generated by the EGR cooler. The storage tank may be located proximate the EGR cooler; in some examples, the storage tank 196 may be the EGR cooler itself (e.g., the EGR cooler may have a condensation collection region). The storage tank 196 may be drained manually, for example once every 100 hours of engine operation. In the example configuration of FIG. 1, no valve is present to control flow of condensate from the EGR cooler to the storage tank. However, to prevent leakage of exhaust gas out of the EGR cooler, the drain out of the EGR cooler may be sealed by the condensate, for example the drain may open only when a threshold level of condensate has accumulated in the EGR cooler. Additional details regarding the EGR cooler are presented below with respect to FIGS. 6-7.

Turning now to FIG. 2, a second example of a condensation management system for the vehicle system 100 is illustrated. In FIG. 2, each of the intercooler 132, mixing region 191, and EGR cooler 166 drain to a common storage tank 202, which may be located away from the engine at a vessel. Due to the different pressures at each respective outlet (e.g., the intercooler outlet may be at 2.25 bar while the mixing region outlet is at 5.23 bar), flow from each outlet may be controlled by a separate valve. Thus, as shown, valve 204 controls flow from the intercooler 132 to the storage tank 202, valve 206 controls flow from the mixing region 191 to the storage tank 202, and valve 208 controls flow from the EGR cooler 166 to the storage tank 202. Each of the condensate flow control valves may be opened according to a command sent by the controller, and may be actuated according a suitable mechanism.

In this way, each of the intercooler, mixing region, and EGR cooler outlets may be maintained at its respective optimal pressure, while only one tank is used to collect the condensate. Further, the tank may be located away from the engine. However, by including three valves, the cost and complexity of control of the condensate management system increases. Additionally, the valve 208 may need to control flow of 100% sulfuric acid during some conditions, and thus the valve may be expensive to manufacture and/or require periodic replacement due to corrosion.

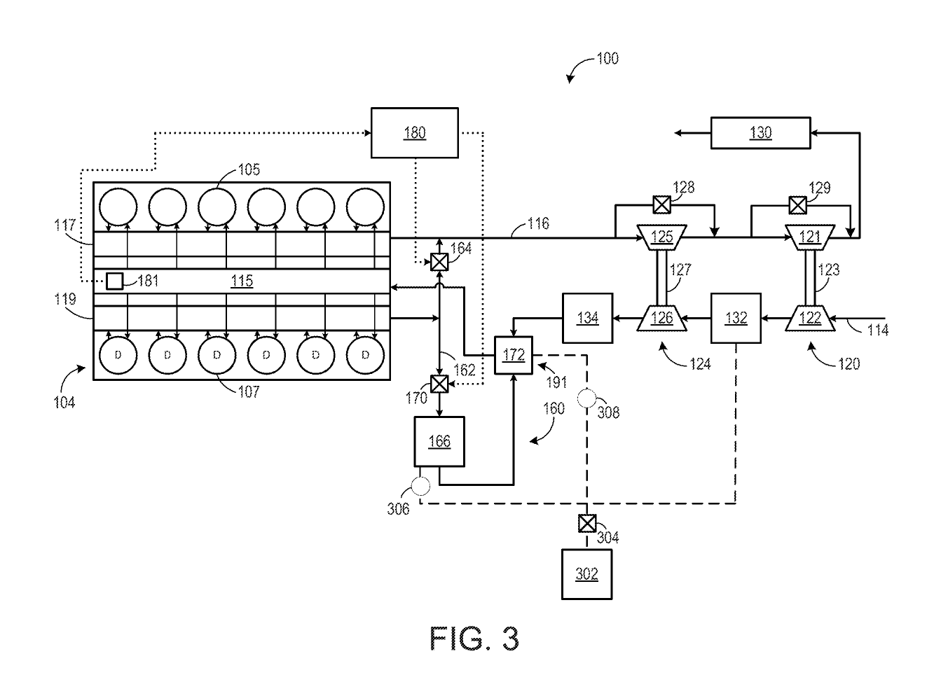

FIG. 3 illustrates a third example of a condensation management system for the vehicle system 100. In FIG. 3, each of the intercooler 132, mixing region 191, and EGR cooler 166 drain to a common storage tank 302, which may be located away from the engine at a vessel. To maintain the proper pressure differential, rather than including three separate valves, two orifices and one valve are used. Specifically, an orifice 306 is located in the line from the EGR cooler 166 to the storage tank 302 and an orifice 308 is located in the line from the mixing region 191 to the storage tank 302. Each of the orifices may cause a pressure drop in the line, such that both lines have the same pressure (e.g., 2.25 bar) as the line leading from the intercooler to the storage tank. One common valve 304 controls flow into the storage tank 302.

Thus, the third example of the condensation management system illustrated in FIG. 3 provides for using only one valve and allows for the condensate to be stored away from the engine. However, the configuration of FIG. 3 may allow for backflow of air from the aftercooler/mixing region to the intercooler. Additionally, under some conditions the valve may be exposed to 100% sulfuric acid from the EGR cooler.

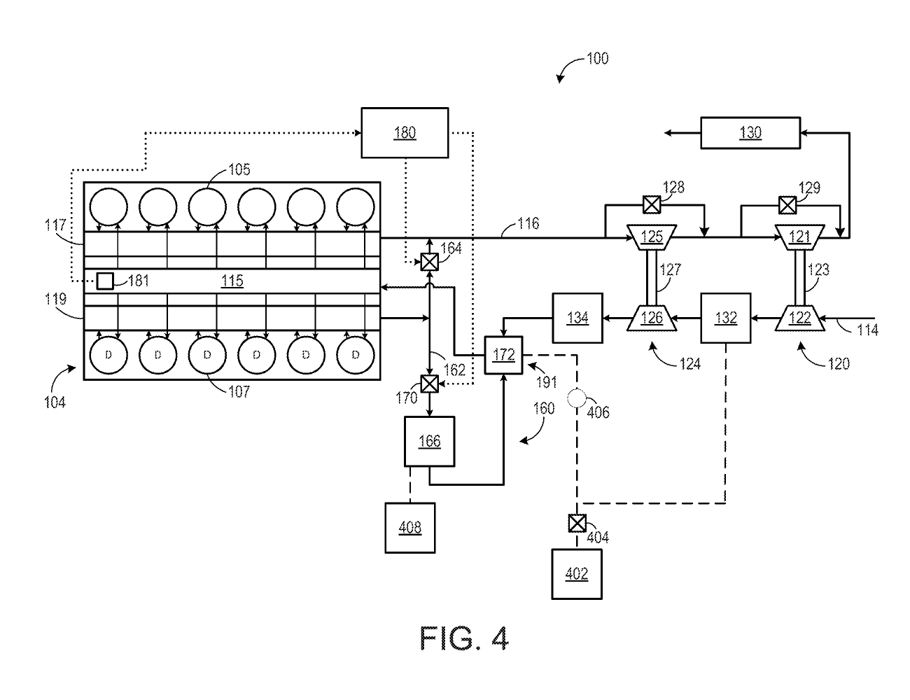

FIG. 4 illustrates a fourth example of a condensation management system for the vehicle system 100. In FIG. 4, intercooler 132 and mixing region 191 each drain to a common storage tank 402. Control of flow into the tank 402 is achieved via valve 404. An orifice 406 is present in the line from the mixing region 191 to the tank to reduce the pressure in the line to be the same pressure as in the line from the intercooler. Condensate from the EGR cooler 166 drains to a separate storage tank 408, which may be located proximate the EGR cooler (e.g., it may be a part of the EGR cooler). This configuration includes only one valve, simplifying control complexity and lowering cost. However, back flow from the mixing region to the intercooler may still occur, and the provision of the sulfuric acid storage tank near the engine may lead to increased risk of degradation, if the tank were to corrode or otherwise leak to the engine.

FIG. 5 illustrates a fifth example of a condensation management system for the vehicle system 100. In FIG. 5, the intercooler 132 includes an automatic valve 190 (e.g., spherical bob) to drain condensate from the intercooler (to ambient, or to a tank). Each of the mixing region 191 and EGR cooler 166 drain to a common storage tank 502, which may be located away from the engine. Control of flow to the storage tank 502 is controlled by valve 504. In this way, only one valve is used and no sulfuric acid tank is located at the engine. However, the valve 504 may be exposed to 100% sulfuric acid.

FIG. 6A illustrates an example EGR cooler system 600 including an EGR cooler 602. EGR cooler 602 is one non-limiting example of EGR cooler 166 of FIGS. 1-5. Exhaust travels through the EGR cooler 602 from an EGR passage 704 via an exhaust inlet 601 where it is cooled via coolant that enters the EGR cooler at coolant inlet 608. EGR cooler 602 includes an exhaust gas outlet 604 configured to expel exhaust from EGR cooler 602 to an EGR passage 606. The exhaust that exits the EGR cooler is directed to the mixing region, where it mixes with intake air before being inducted to the engine. The coolant exits the EGR cooler via a coolant outlet 615 to a coolant line 609.

FIG. 6B illustrates another embodiment 601 the EGR cooler 602 including a condensate drain line 618 to drain condensate from the EGR cooler, thereby preventing corrosion and degradation of the EGR cooler. The role of the condensate drain line in draining exhaust from the EGR cooler will be described below in further details with reference to FIGS. 10-12.

FIGS. 7A and 7B show additional views of the EGR cooler system 600. FIG. 7A shows a top-down view of the EGR cooler system 600 in combination with an engine 700, such as engine 104 of FIG. 1. As explained above, the EGR cooler system 600 includes the EGR cooler 602, exhaust gas outlet 604 that supplies EGR to EGR passage 606, and coolant inlet 608. The EGR cooler 602 is mounted to the engine via a support bracket 603. Coolant inlet 608 receives coolant from a coolant passage 612.

FIG. 7A additionally illustrates an exhaust gas inlet 702 that receives EGR from an EGR passage 704 that receives exhaust gas from one or more cylinders of the engine (e.g., donor cylinders) via passage 711. As explained above with respect to FIG. 1, flow of EGR is controlled by one or more exhaust valves, herein shown as first EGR valve 707 and second EGR valve 709. First EGR valve 707 may be a non-limiting example of first valve 164 of FIG. 1, and second EGR valve 709 may be a non-limiting example of second valve 170 of FIG. 1. Accordingly, EGR flows to EGR cooler 602 via second EGR valve 709. Any remaining exhaust gas that does not flow to the EGR cooler 602 is routed to atmosphere via first EGR valve 707 and exhaust passage 713. Exhaust passage 713 may also receive exhaust gas from the non-donor cylinders. A connecting passage 710 may connect the exhaust passage 713 and the passage 711. Exhaust gas in passage 713 may flow through one or more turbochargers and/or aftertreatment systems (housed within structure 715) before being admitted to atmosphere.

Further, FIG. 7A shows a coolant outlet 706, where coolant that has traveled through the EGR cooler exits to be supplied to a cooling system component, such as a heater core, radiator, or the like. As shown in FIG. 7A, the EGR passage 606, coolant passage 612, passage 704, and passage 713 are all positioned laterally above the engine and traverse across the engine with a longitudinal axis parallel to the longitudinal axis of the engine. Further one or more of the passages may be coupled to an intake manifold 611 (shown in FIG. 6 and removed from FIG. 7A for clarity) of the engine. However, other configurations are possible.

FIG. 7B shows a side view of the EGR cooler system 600, specifically from the side of the exhaust gas outlet 604. Shown in FIG. 7B is a condensate collecting region 610 to collect condensate from the EGR cooler. The condensate collecting region may collect condensate from the lowest point of the EGR cooler. A drain (not shown) may be present to allow the condensate to be removed from the EGR cooler. The drain may be a manual drain or an automatic drain.

The EGR cooler may generate condensate that is relatively high in sulfuric acid. Sulfur present in the fuel may be converted to gaseous sulfur dioxide during combustion. The sulfur dioxide may react with oxygen in the exhaust to form sulfur trioxide. Sulfur trioxide can react with moisture in the exhaust to form sulfuric acid. Sulfuric acid may condense at higher temperatures than water, and thus at typical EGR cooler temperatures, condensation of sulfuric acid may occur. Under some conditions, the condensate in the EGR cooler may be comprised of 100% sulfuric acid. If this condensate was allowed to accumulate in the EGR cooler, it may cause corrosion. Further, the condensate could also cause engine corrosion if allowed to travel to the engine.

Thus, the condensate collecting region 610 may collect the sulfuric acid condensate, preventing it from remaining on the surfaces of the EGR cooler and traveling to the engine. The condensate collecting region, as well as the surfaces of the EGR cooler, may be made of corrosion resistant material, such as a stainless steel alloy including copper, molybdenum, and/or other metals that increase resistance to corrosion by sulfuric acid, and/or may be coated with a material to increase corrosion resistance.

Turning now to FIG. 8, another example for a condensate management system 800 is illustrated. System 800 includes an aftercooler 802 (which may be a non-limiting example of charge air cooler 134), through which flows intake air. After passing through the aftercooler, the intake air is directed to an intake passage, for eventual induction at the engine. An EGR cooler 806 cools EGR and passes the EGR to an EGR passage 808. The cooled EGR eventually mixes with the intake air at a mixing region 810, and is inducted at the engine. EGR cooler 806 may include any of the EGR coolers described herein. For example, EGR cooler 806 may be a non-limiting example of EGR cooler 166, EGR cooler 602, etc.

To manage the condensate, EGR cooler 806 includes a condensation collector 814, which may be a chamber at the lowest point of the EGR cooler configured to store condensate that collects in the collector via gravity. At certain engine operating points the temperature of the coolant in the EGR cooler and/or exhaust gas in the EGR cooler is low, resulting in higher condensation which is collected in the chamber. This collected condensate is then re-evaporated when the engine is operating at points where the coolant's and/or exhaust temperature becomes higher. The EGR cooler also includes a diverter 812 positioned to divert the flow of EGR through the EGR cooler. The diverter causes the flow of EGR to be directed to the collector and sweep the collected condensate to the EGR passage along with the EGR, for eventual combustion at the engine. Alternatively or additionally, the diverter may act to direct high-temperature exhaust gas to the chamber, where the high temperature exhaust gas evaporates the collected condensate. Likewise, the intake passage 804 includes a condensate collector 818 and a diverter 816 to divert the charge air flow toward the collector and sweep any collected condensate to the engine.

FIG. 9 illustrates a still further example of a condensate management system 900. System 900 includes an EGR cooler 902, which may be the EGR cooler 166, EGR cooler 806, and/or the EGR cooler 602 discussed above. A heater 904 is configured to heat the exhaust gas exiting the EGR cooler when activated. As shown, the heater 904 is positioned in the EGR passage downstream of the EGR cooler. An acid dew point temperature (ADT) sensor 906 is also positioned in the EGR passage to receive EGR from the EGR cooler. The ADT sensor may detect the acid dew formation within the EGR cooler.

An engine management system 908, which may be the control system discussed above, is configured to receive feedback from the ADT sensor. When the information from the ADT sensor indicates that acidic condensation is forming, the heater is activated, it increases the temperature of the exhaust gas and prevents formation of acidic condensation.

FIG. 10 illustrates a schematic of the vehicle system 100 with a condensate management system 950 including a condensate line 118 connecting the EGR cooler 166 to the exhaust passage 116. Draining condensate from the EGR cooler by the condensate line 118 may prevent condensate build up, reducing corrosion of the EGR cooler and other associated engine components. In one example, the condensate line 118 may connect to the exhaust passage 116 downstream of the first turbine 121 of the first turbocharger 120 (low pressure turbocharger), as illustrated in FIG. 10. In other examples, the condensate line 118 may join the exhaust passage 116 downstream of the second turbocharger 124, upstream of the second turbocharger 124, or upstream of the first turbocharger 120. In one example, a valve may regulate the flow of condensate from the EGR cooler through the condensate line 118 to the exhaust passage 116.

The condensate from the EGR cooler 166 may thus be drained through the condensate line 118 into the exhaust passage 116. The condensate will evaporate due to the high temperature in the exhaust line and mix with the exhaust, which may reduce risk of corrosion in the exhaust line. The condensate may then flow along with the exhaust through the exhaust gas treatment system 130 to atmosphere.

The condensate from each of the mixing region 191 may drain to a tank, for example the storage tank 502, which may be located away from the engine. Condensate from the intercooler 132 may drain to a tank or to ambient, regulated by a valve, as described above with reference to FIGS. 1-5.

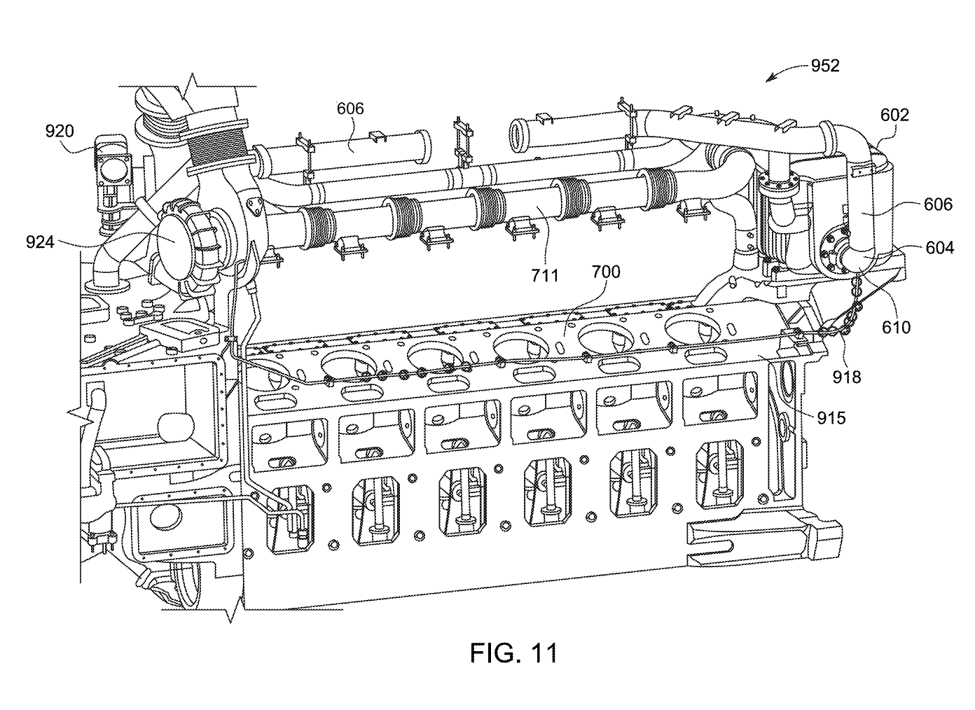

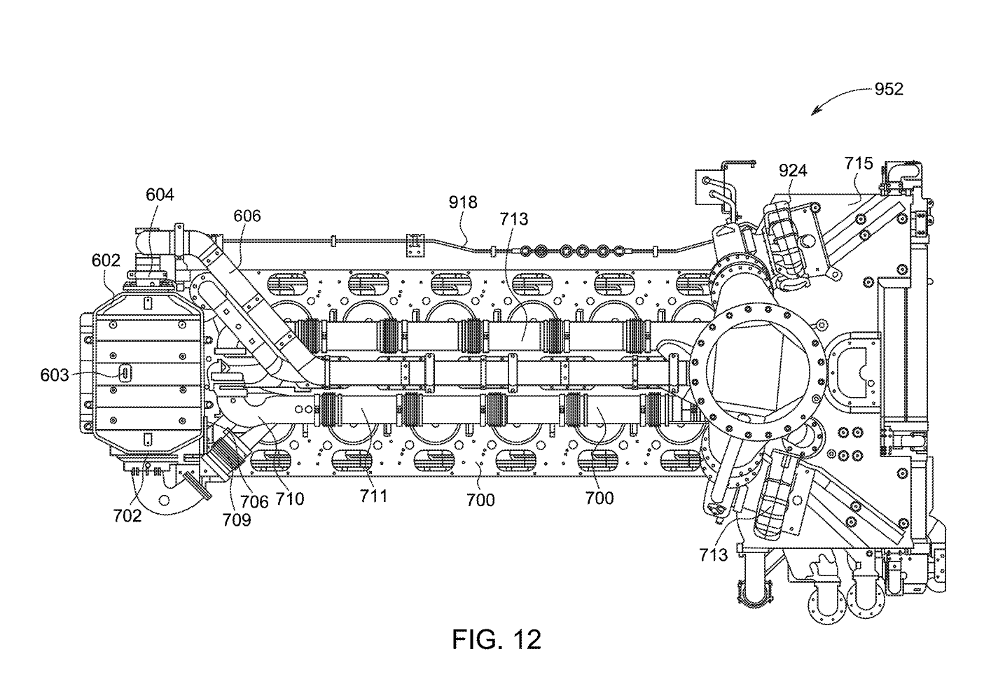

FIG. 11 shows an embodiment of an EGR cooler system 952, including a condensate line 918, similar to the condensate line 118 illustrated in FIG. 10. FIG. 12 shows another view of the EGR cooler system 952. The EGR cooler system 952 includes the EGR cooler 602. The EGR condensate line 918 connects the EGR cooler 602 to a location within the exhaust system, such as an exhaust passage, similar to the exhaust passage 116 of FIG. 1. In one example, the condensate line 918 may connect to the exhaust passage downstream of a first turbocharger 924, similar to the first turbocharger 120 of FIG. 1. In other examples, the condensate line may join the exhaust passage upstream of the first turbocharger 924, upstream of a second turbocharger 920, or other suitable location. However, as shown, the condensate line 918 fluidically couples the EGR cooler to the turbine outlet of the low-pressure turbocharger.

The condensate line 918 may be positioned to run along an intake manifold 915 of the engine 700. In one example, the condensate line 918 may be positioned such that condensate that may collect due to gravitational force at the bottom the EGR cooler may flow out of the EGR cooler through the condensate line. In another example condensate may flow out due to the pressure difference between the two lines. In another example, a storage tank may be present at the bottom of the EGR cooler. The condensate may collect in the storage tank and flow out of the EGR cooler through the condensate line. In another example, a valve may regulate flow of condensate from the EGR cooler through the condensate line to the exhaust passage. The valve may be a unidirectional valve, allowing fluid flow from the EGR cooler through the condensate line towards the exhaust passage but not from the exhaust passage to the EGR cooler. In one example, the valve position may be regulated by a controller based on the volume of condensate present in the EGR cooler. If condensate level in EGR cooler is above a threshold, the valve may be positioned to flow condensate from the EGR cooler to the exhaust passage through the condensate line. Condensate line 918 may be comprised of stainless steel or hose material compatible with sulfuric acid and able to withstand high exhaust temperatures, and the condensate line may be supported by brackets.

An example of a system includes an intercooler positioned in an intake passage downstream of a turbocharger compressor configured to provide compressed intake air to an engine; an exhaust gas recirculation (EGR) system including an EGR cooler defining at least a portion of an EGR passage and communicating with a mixing region where exhaust gas mixes with the compressed intake air; a condensate collector fluidly coupled to the EGR cooler to collect condensate from the EGR cooler, the condensate collector positioned within the EGR cooler; and a drain line coupled to the condensate collector, the drain line having an outlet fluidically coupled downstream of a turbocharger turbine.

In an example, the drain line outlet may be fluidically coupled to an outlet of the turbocharger turbine. The system may further comprise a diverter in the EGR cooler, the diverter positioned to divert EGR flow through the EGR cooler to the condensate collector. The diverter may be a first diverter and the condensate collector may be a first condensate collector, and the system may further include a second diverter and a second condensate collector positioned in the intake passage downstream of the mixing region, the second diverter positioned to divert charge air flow toward the second condensate collector. The turbocharger compressor may be a first turbocharger compressor, and the system may further comprise a second turbocharger compressor, the intercooler positioned between the first turbocharger compressor and the second turbocharger compressor.

The EGR cooler may be configured to receive coolant from a coolant passage and to receive exhaust from an engine exhaust passage. In an example, the EGR passage, coolant passage, and engine exhaust passage are each positioned laterally above the engine. In such an example, the EGR cooler may additionally be positioned laterally above the engine. In another example, the EGR cooler may be positioned on a side of the engine and one or more of the EGR passage, coolant passage, and engine exhaust passage may also extend along a side of the engine.

Another example of a system includes an intercooler positioned in an intake passage downstream of a turbocharger compressor configured to provide compressed intake air to an engine; an exhaust gas recirculation (EGR) system including an EGR cooler defining at least a portion of an EGR passage and communicating with a mixing region where exhaust gas mixes with the compressed intake air; and a storage tank fluidly coupled to the EGR cooler to collect condensate from the EGR cooler, the storage tank located remotely from the EGR cooler.

The storage tank may be a first storage tank and the system may further include a second storage tank to collect condensate from the mixing region and a valve positioned in a line between the mixing region and the second storage tank. The system may further include an automatic valve positioned in the intercooler, the automatic valve configured to seal a drain of the intercooler when a level of condensate in the intercooler is below a threshold level. The line may be a first flow line, the second storage tank configured to collect condensate from the mixing region via the first flow line, and the system may further include a second flow line fluidly coupling the second storage tank to the intercooler, and an orifice positioned in the first flow line.

The storage tank may be fluidly coupled to the mixing region and to the intercooler. The system may further include a first flow line including a first flow valve fluidly coupling the EGR cooler to the storage tank, a second flow line including a second flow valve fluidly coupling the mixing region to the storage tank, and a third flow line including a third flow valve fluidly coupling the intercooler to the storage tank, each flow valve configured to maintain a desired respective pressure differential within each flow line. The system may further include a first flow line including a first orifice fluidly coupling the EGR cooler to the storage tank, a second flow line including a second orifice fluidly coupling the mixing region to the storage tank, and a third flow line fluidly coupling the intercooler to the storage tank, the first and second orifice each configured to maintain a downstream pressure equal to a pressure in the third flow line. The first, second, and third flow lines may form a common flow line coupled to an inlet of the storage tank, and the system may further include a flow valve controlling flow through the common flow line.

The storage tank may be fluidly coupled to the mixing region, and the system may further include: a flow valve to control flow of condensate from the EGR cooler and mixing region to the storage tank; and an automatic valve positioned in the intercooler, the automatic valve sealing a drain of the intercooler when a level of condensate in the intercooler is below a threshold level.

The system may further include: a heater positioned in the EGR passage; a dew point sensor positioned in the EGR passage; and an electronic controller storing non-transitory instructions for activating the heater when output from the dew point sensor indicates condensation in the EGR exiting the EGR cooler is above a threshold.

A further example of a system includes an intercooler positioned in an intake passage downstream of a turbocharger compressor; an exhaust gas recirculation (EGR) system including an EGR cooler defining at least a portion of an EGR passage and communicating with a mixing region where exhaust gas mixes with the compressed intake air; a storage tank fluidly coupled to the mixing region; an automatic valve positioned in the intercooler, the automatic valve sealing a drain of the intercooler when a level of condensate in the intercooler is below a threshold level; a condensate collector fluidly coupled to the EGR cooler to collect condensate from the EGR cooler; and a drain line coupled to the condensate collector, the drain line having an outlet fluidically coupled downstream of a turbocharger turbine. The outlet of the drain line may be fluidically coupled to an outlet of the turbocharger turbine. The turbocharger turbine may be a first turbocharger turbine positioned in an exhaust passage downstream of a second turbocharger turbine. Any or all of the above-described systems may be included in a vehicle. The vehicle may include a platform, a diesel engine attached to the platform, and any or all of the above-described systems attached to the platform, with the intake passage coupled to an intake of the engine and the EGR system coupled to an exhaust of the engine.

As used herein, an element or step recited in the singular and proceeded with the word “a” or “an” should be understood as not excluding plural of said elements or steps, unless such exclusion is explicitly stated. Furthermore, references to “one embodiment” of the invention do not exclude the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A system, comprising:
an intercooler positioned in an intake passage downstream of a turbocharger compressor configured to provide compressed intake air to an engine;
an exhaust gas recirculation (EGR) system including an EGR cooler defining at least a portion of an EGR passage and communicating with a mixing region where exhaust gas mixes with the compressed intake air;
a condensate collector fluidly coupled to the EGR cooler to collect condensate from the EGR cooler, the condensate collector positioned within the EGR cooler; and
a drain line coupled to the condensate collector, the drain line having an outlet fluidically coupled downstream of a turbocharger turbine.

2. The system of claim 1, wherein the drain line is coupled to an outlet of the turbocharger turbine.

3. The system of claim 2, wherein the condensate collector is a first condensate collector, and further comprising a first diverter in the EGR cooler, the first diverter positioned to divert EGR flow through the EGR cooler to the first condensate collector, a second diverter, and a second condensate collector positioned in the intake passage downstream of the mixing region, the second diverter positioned to divert charge air flow toward the second condensate collector.

4. The system of claim 1, wherein the turbocharger compressor is a first turbocharger compressor, and further comprising a second turbocharger compressor, the intercooler positioned between the first turbocharger compressor and the second turbocharger compressor.

5. The system of claim 1, wherein the EGR cooler is configured to receive coolant from a coolant passage and to receive exhaust from an engine exhaust passage, the EGR passage, coolant passage, and engine exhaust passage each positioned laterally above the engine.

6. A system, comprising:
an intercooler positioned in an intake passage downstream of a turbocharger compressor configured to provide compressed intake air to an engine;
an exhaust gas recirculation (EGR) system including an EGR cooler defining at least a portion of an EGR passage and communicating with a mixing region where exhaust gas mixes with the compressed intake air; and
a storage tank fluidly coupled to the EGR cooler to collect condensate from the EGR cooler, the storage tank located remotely from the EGR cooler.

7. The system of claim 6, wherein storage tank is a first storage tank and further comprising a second storage tank to collect condensate from the mixing region and a valve positioned in a line between the mixing region and the second storage tank.

8. The system of claim 7, further comprising an automatic valve positioned in the intercooler, the automatic valve sealing a drain of the intercooler when a level of condensate in the intercooler is below a threshold level.

9. The system of claim 7, wherein the line is a first flow line, the second storage tank configured to collect condensate from the mixing region via the first flow line, and further comprising a second flow line fluidly coupling the second storage tank to the intercooler, and an orifice positioned in the first flow line.

10. The system of claim 6, wherein the storage tank is fluidly coupled to the mixing region and to the intercooler.

11. The system of claim 10, further comprising a first flow line including a first flow valve fluidly coupling the EGR cooler to the storage tank, a second flow line including a second flow valve fluidly coupling the mixing region to the storage tank, and a third flow line including a third flow valve fluidly coupling the intercooler to the storage tank, each flow valve configured to maintain a desired respective pressure differential within each flow line.

12. The system of claim 10, further comprising a first flow line including a first orifice fluidly coupling the EGR cooler to the storage tank, a second flow line including a second orifice fluidly coupling the mixing region to the storage tank, and a third flow line fluidly coupling the intercooler to the storage tank, the first and second orifice each configured to maintain a downstream pressure equal to a pressure in the third flow line.

13. The system of claim 12, wherein the first, second, and third flow lines form a common flow line coupled to an inlet of the storage tank, and further comprising a flow valve controlling flow through the common flow line.

14. The system of claim 6, wherein the storage tank is fluidly coupled to the mixing region, and further comprising:
a flow valve to control flow of condensate from the EGR cooler and mixing region to the storage tank; and
an automatic valve positioned in the intercooler, the automatic valve sealing a drain of the intercooler when a level of condensate in the intercooler is below a threshold level.

15. The system of claim 6, further comprising:
a heater positioned in the EGR passage;
a dew point sensor positioned in the EGR passage; and
an electronic controller storing non-transitory instructions for activating the heater when output from the dew point sensor indicates condensation in the EGR exiting the EGR cooler is above a threshold.

16. A vehicle comprising:
a platform; and
the system of claim 6 attached to the platform, wherein the engine is a diesel engine.

17. A system, comprising:
an intercooler positioned in an intake passage downstream of a turbocharger compressor;
an exhaust gas recirculation (EGR) system including an EGR cooler defining at least a portion of an EGR passage and communicating with a mixing region where exhaust gas mixes with the compressed intake air;
a storage tank fluidly coupled to the mixing region;
an automatic valve positioned in the intercooler, the automatic valve sealing a drain of the intercooler when a level of condensate in the intercooler is below a threshold level;
a condensate collector fluidly coupled to the EGR cooler to collect condensate from the EGR cooler; and
a drain line coupled to the condensate collector, the drain line having an outlet fluidically coupled downstream of a turbocharger turbine.

18. The system of claim 17, wherein the outlet of the drain line is fluidically coupled to an outlet of the turbocharger turbine.

19. The system of claim 18, wherein the turbocharger turbine is a first turbocharger turbine positioned in an exhaust passage downstream of a second turbocharger turbine.

20. A vehicle comprising:
a platform;
a diesel engine attached to the platform;
the system of claim 17 attached to the platform, wherein the intake passage is coupled to an intake of the engine and the EGR system is coupled to an exhaust of the engine.
